(19) United States
(12) Patent Application Publication
(10) Pub. No.: US 2008/0212254 A1
(43) Pub. Date: Sep. 4, 2008

(54) Control Circuit For a Switching Arrangement

(75) Inventors: Bastian Arndt, Eilsbrunn (DE); Ralf Forster, Regensburg (DE); Gunther Wolfarth, Regensburg-Harting (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 11/792,166

(22) PCT Filed: Nov. 25, 2005
(86) PCT No.: PCT/EP05/56241

§ 371 Date: Jun. 1, 2007

(30) Foreign Application Priority Data
Dec. 1, 2004 (DE) 10 2004 058 018.9

(51) Int. Cl. H01H 47/04

(52) U.S. Cl. 361/194

(57) ABSTRACT

A control circuit for a switching device with a relay and a switch. The control circuit is configured in such a way as to produce a hold signal for a predetermined period of time when a start signal is supplied thereto. The control circuit is also configured in such a way as to produce the hold signal for the predefined period of time independently of the course of the start signal during the predefined period of time. The control circuit is also configured in order to activate a switch output when at least one of two conditions is met. The switch enables the relay to be supplied with current when the switch output is activated, otherwise it prevents the relay from being supplied with current.

The invention relates to a control circuit for a switching arrangement which comprises a relay and a switch which enables the relay to be supplied with current or prevents the relay from being supplied with current depending on its switch setting.

DE 100 05 778 Al discloses a circuit arrangement for controlling a relay which electrically connects a starter of an internal combustion engine which is disposed in a motor vehicle to a battery or disconnects it from same. The circuit arrangement is embodied such that the relay remains activated in the event of the battery's being subject to a time-limited voltage dip. A memory circuit having a locking circuit is arranged electrically between a computer and an end stage for controlling the relay. In the event that the battery experiences a voltage dip the memory circuit stores a switching signal which is generated by the computer and in this way maintains the corresponding switch setting of the relay. The computer, which switches to a reset state during the voltage dip of the battery, is reactivated once the battery's voltage dip has ceased and controls the locking circuit in such a way that the relay is once again brought under the control of the computer via the switching signal.

DE 101 03 638 B4 discloses a device and a method for starting an internal combustion engine. The device comprises two switching means for establishing an electrical connection between a starter and a voltage source. The device further comprises a control device having a computer unit, a first and second switch and a self-locking means. A starting signal from an ignition lock can be supplied to the computer unit and the first and second switch. Said two switches are in each case coupled to one of the two switching means in such a way that the respective switching means is activated when the associated switch is closed. The self-locking means is coupled to the starter on the input side and to the first switch on the output side. The self-locking means is connected in such a way that it can keep the first switch closed for a predefined period of time even when the starting signal is no longer applied.

The object of the invention is to create a control circuit which reliably controls a relay.

The object is achieved by the features of the independent claims. Advantageous developments of the invention are characterized in the dependent claims.

The invention is characterized by a control circuit for a switching arrangement which comprises a relay and a switch. The switch enables the relay to be supplied with current or prevents it from being supplied with current as a function of its switch setting. The control circuit is embodied for generating a hold signal for a predefined period of time when it is supplied with a start signal. The start signal is formed by means of a reset signal or is generated by means of a logic operation from the reset signal and a switching signal or is generated by a deactivation of the switching signal. Furthermore the control circuit is embodied for generating the hold signal for the predefined period of time irrespective of a further characteristic of the start signal during said predefined period of time. The control circuit is also embodied for activating a switch output as long as at least one of two conditions is fulfilled and otherwise for deactivating the switch output. The first condition is fulfilled when the control circuit is supplied with the switching signal. The second condition is fulfilled if the switch output is activated at the commencement of the generation of the hold signal and the hold signal is generated. The switch output is electrically coupled to the switch in such a way that the switch enables the relay to be supplied with current when the switch output is activated and otherwise the switch prevents the relay from being supplied with current.

The advantage of the control circuit is that the hold signal is generated for the predefined period of time irrespective of a further characteristic of the start signal during said predefined period of time. As a result the control circuit is rendered robust against interference signals which may occur during the predefined period of time. This ensures that the hold signal is generated only for the predefined period of time that follows the point in time at which the start signal was triggered. This allows reliable control of the relay.

The control circuit can preferably be coupled to a control unit which is embodied to generate the switching signal and supply it to the control circuit. The control unit can thus control the relay via the control circuit and the switch. The start signal is preferably generated when the control unit is reset. The control circuit then has the advantage that a switch status of the relay can be maintained while the control unit is reset and consequently a starting operation, of a motor vehicle for example, is also possible even with a low battery voltage. For safety reasons, however, the supplying of current to the relay is terminated after the predefined period of time has expired if the control unit cannot yet generate the switching signal again because, for example, the resetting of the control unit has not yet been terminated. The resetting of the control unit can be triggered for example by the too low battery voltage which may occur in the motor vehicle during a starting phase of an internal combustion engine.

Furthermore the control circuit can be embodied easily and inexpensively as an application-specific integrated circuit. The control circuit can be embodied such that it can be easily diagnosed, by the control unit for example, in order to be able to ensure reliable operation of the control circuit. The control unit can also be embodied for example to control actuating elements of the internal combustion engine of the motor vehicle or to record measured values from sensors of the internal combustion engine.

In an advantageous embodiment the control circuit has a clocked counter which is embodied to be started by the start signal and to generate the hold signal for the predefined period of time. This has the advantage that a control circuit of this kind can be easily integrated into an application-specific integrated circuit, since no capacity is required for specifying the period of time. Furthermore this enables the control circuit to be easily checked. The clocked counter cannot be started again until the predefined period of time has expired.

In a further advantageous embodiment the control circuit has a mono-flop which is embodied to be started by the start signal and to generate the hold signal for the predefined period of time. The mono-flop cannot be started again until the predefined period of time has elapsed.

In a further advantageous embodiment the control circuit is embodied to deactivate the switch output as a function of a stop signal if the switching signal is not generated and the hold signal is generated. The control unit is preferably embodied to generate the stop signal and supply it to the control circuit. The control unit can thus deactivate the switch output even before the predefined period of time has expired. The advantage is that the relay is supplied with current only for as long as necessary.

In this connection it is advantageous if the control circuit is embodied for inhibiting or allowing the switch output to be deactivated by the stop signal as a function of a stop control signal. This has the advantage that an unintended deactivation of the switch output can be prevented by the inhibiting of the stop signal. The control circuit is thus robust against interference signals which may occur in particular as a result of the resetting of the control unit.

In a further advantageous embodiment of the control circuit a comparator is provided which is electrically coupled to the switch and which determines a switch status value of the switch by comparing a voltage drop across the switch with a predefined threshold voltage. This has the advantage that the actual switch setting of the switch can be easily determined.

Exemplary embodiments of the invention are explained below with reference to the schematic drawings, in which:

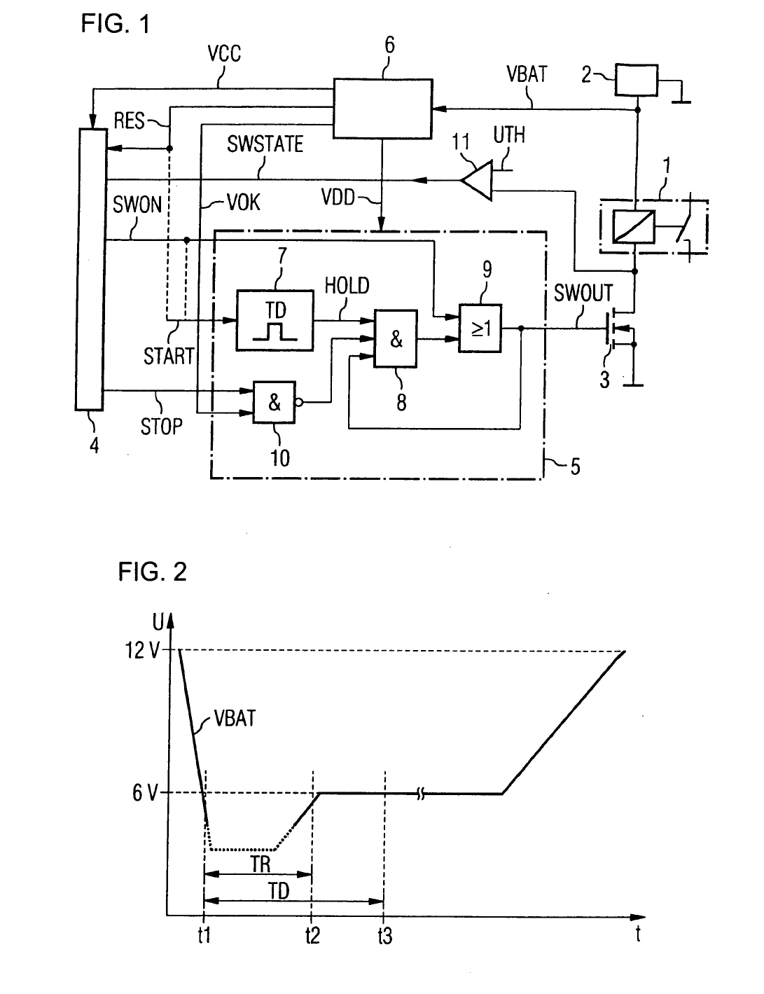

FIG. 1 shows a switching arrangement,

FIG. 2 shows a voltage-time diagram.

Elements of identical construction or function are designated by the same reference symbols in both figures.

FIG. 1 shows a switching arrangement comprising a relay 1, a battery 2, a switch 3, a control unit 4, a control circuit 5 and a voltage conditioning unit 6. FIG. 2 shows a voltage-time diagram of a battery voltage VBAT of the battery 2 during a start phase of an internal combustion engine in a motor vehicle. The battery 2 has a rated voltage of 12 volts. The battery 2 may also have a different rated voltage, however.

The battery voltage VBAT dips during the start phase due to a high current requirement on the part of the starter, to around 6 volts for example. The start phase lasts for up to 10 seconds for example. For a brief period of time, for approximately 50 to 100 milliseconds for example, the battery voltage VBAT can dip to less than 6 volts. The voltages are dependent on a charge condition of the battery 2 and on the respective vehicle.

The battery is electrically coupled to the relay 1 and the voltage conditioning unit 6 and supplies these with the battery voltage VBAT. The relay 1 is electrically coupled to the switch 3. The switch 3 enables the relay 1 to be supplied with current or prevents it from being supplied with current as a function of a switch setting of the switch 3. The relay 1 is embodied for switching electrical loads, such as, for example, a starter or a fuel pump in a motor vehicle.

The voltage conditioning unit 6 is electrically coupled to the control unit 4 and the control circuit 5. From the battery voltage VBAT supplied to it the voltage conditioning unit 6 generates an operating voltage VCC of the control unit 4 and an operating voltage VDD of the control circuit 5. The operating voltage VDD can also be generated separately by the voltage conditioning unit 6 from the battery voltage VBAT or from another voltage source. The voltage conditioning unit 6 is also embodied for generating a reset signal RES and a voltage status signal VOK.

The reset signal RES is generated at a time t1 at which the battery voltage VBAT is less than a minimum voltage, for example 5.5 volts, which is necessary in order to generate the operating voltage VCC of the control unit 4, which amounts to 5 volts for example. The reset signal RES is supplied to the control unit 4 and resets the latter.

For the purpose of maintaining the operating voltage VDD of the control circuit 5, which amounts for example to 3.5 volts, a smaller minimum voltage is preferably required than for maintaining the operating voltage VCC of the control unit 4, with the result that the control circuit 5 can also continue to be operated when the operating voltage VCC of the control unit 4 is no longer available.

The voltage status signal VOK signals that the operating voltage VCC of the control unit 4 is available and the control unit 4 can be operated. This is the case prior to the time t1 and after a time t2 when the battery voltage VBAT is once again greater than the minimum voltage. The voltage status signal VOK is thus generated for a period of time TR from time t1 to time t2.

The control unit 4 is electrically coupled to the control circuit 5 and the control circuit 5 is electrically coupled to the switch 3. The control unit 4 is embodied for generating a switching signal SWON for controlling the switch 3 by means of the control circuit 5. The switching signal SWON is supplied to the control circuit 5. The switching signal SWON can also be generated for example by means of a mechanical switch, such as the ignition switch, or in some other way. The control circuit 5 has a switch output SWOUT which is electrically coupled to the switch 3. The switch 3 prevents current from being supplied to the relay 1 if the switch output SWOUT is deactivated and enables current to be supplied to the relay 1 if the switch output SWOUT is activated.

The control circuit 5 comprises a time switch device 7, an AND gate 8, an OR gate 9 and a NAND gate 10. The switching signal SWON is supplied to the OR gate 9 at a first input of the OR gate 9. An output of the OR gate 9 forms the switch output SWOUT which is coupled to a first input of the AND gate 8. An output of the AND gate 8 is coupled to a second input of the OR gate 9.

The reset signal RES forms a start signal START which is supplied to the time switch device 7. Alternatively the start signal START can also be generated by a deactivation of the switching signal SWON. Alternatively the start signal START can also be generated by means of a logic operation from the reset signal RES and the switching signal SWON or in some other way.

The time switch device 7 is embodied for generating a hold signal HOLD which is supplied to the AND gate 8 at a second input of the AND gate 8. The control unit 4 is furthermore embodied for generating a stop signal STOP which is supplied to the NAND gate 10. The NAND gate 10 is also supplied with the voltage status signal VOK. An output of the NAND gate 10 is coupled to a third input of the AND gate 8.

The time switch device 7, which is embodied for example as a monostable multivibrator circuit, which is also referred to as a mono-flop, or as a clocked counter, is started by means of the start signal START, by means of a falling edge for example, and thereupon generates the hold signal HOLD for a predefined period of time TD. The predefined period of time TD is generated from time t1 to a time t3 and preferably amounts to between 200 milliseconds and 2 seconds, but can also be shorter or longer.

The switch output SWOUT is activated if the switching signal SWON is generated by the control unit 4. The switch output SWOUT is also activated if the time switch device 7 generates the hold signal HOLD, the output of the NAND gates 10 is activated and if the switch output SWOUT is activated at the commencement of the generation of the hold signal HOLD. Otherwise the switch output SWOUT is deactivated.

As a result of the resetting of the control unit 4 the switching signal SWON is not generated by the control unit 4, so that while the control unit 4 is being reset the switch output SWOUT remains activated for the predefined period of time T if the switch output SWOUT was already activated at time t1. After the predefined period of time TD has expired, the switch output SWOUT is deactivated if the control unit 4 does not generate the switching signal SWON again by time t3. During the predefined period of time TD the time switch device 7 cannot be restarted by the start signal START. This ensures that no more current is supplied to the relay 1 at the latest at time t3 if the supplying of current to the relay is not maintained by the generation of the start signal SWON. The control circuit 5 is thus robust against interference signals which may occur in particular during the start phase of the internal combustion engine of the motor vehicle.

During the predefined period of time TD the switch output SWOUT can be deactivated if the voltage status signal VOK signals by means of an H level that the operating voltage VCC of the control unit 4 is available and if the control unit 4 generates the stop signal. This enables the supplying of current to the relay 1 to be discontinued if the control unit 4 is ready for operation again after being reset. In this way it is possible to prevent the relay 1 from being supplied with current for an unnecessarily long time. The voltage status signal VOK is used as a stop control signal which inhibits the stop signal STOP for the period of time TR by means of an L level and after the period of time TR has expired enables it again by means of an H level. The switch output SWOUT can therefore only be deactivated between time t2 and time t3 if the period of time TR is shorter than the predefined period of time TD. If the period of time TR is longer than the predefined period of time TD, the switch output SWOUT is deactivated after the predefined period of time TD has expired.

The switching arrangement also has a comparator 11 which is electrically coupled to the switch 3 and the relay 1 on the input side in such a way that the comparator 11 is supplied with a voltage drop across the switch 3. The comparator 11 is also supplied with a threshold voltage UTH. The comparator 11 compares the voltage drop across the switch 3 with the threshold voltage UTH and as a function thereof generates a switch status value SWSTATE which is supplied to the control unit 4. The threshold voltage UTH, which amounts for example to approximately 2 volts, is dimensioned such that the switch setting of the switch 3, i.e. the switch 3 is closed or the switch 3 is open, is supplied to the control unit 4 by means of the switch status value SWSTATE.

1-6. (canceled)

7. A control circuit for a switching configuration having a relay and a switch, wherein the switch enables the relay to be supplied with current or prevents the relay from being supplied with current depending on a switch setting thereof, the control circuit comprising:
an input for receiving a start signal and a switch output connected to the switch of the switching configuration, and the control circuit being configured to:
generate a hold signal for a predefined period of time upon receiving the start signal, wherein the start signal is formed by way of a reset signal or generated by way of a logic operation from the reset signal and a switching signal or generated by a deactivation of the switching signal;
generate the hold signal for the predefined period of time irrespective of a further characteristic of the start signal during the predefined period of time; and
activate the switch output as long as at least one of two conditions is fulfilled and otherwise deactivating the switch output, the two conditions including a first condition being fulfilled when the control circuit is supplied with the switching signal and a second condition being fulfilled if the switch output is activated at a commencement of a generation of the hold signal and the hold signal is generated; and
wherein said switch output is electrically coupled to the switch such that the switch enables the relay to be supplied with current when said switch output is activated and otherwise the switch prevents the relay from being supplied with current.

8. The control circuit according to claim 7, which comprises a clocked counter configured to be started by the start signal and to generate the hold signal for the predefined period of time.

9. The control circuit according to claim 7, which comprises a mono-flop configured to be started by the start signal and to generate the hold signal for the predefined period of time.

10. The control circuit according to claim 7, configured to deactivate the switch output as a function of a stop signal if the switching signal is not generated and the hold signal is generated.

11. The control circuit according to claim 10, configured to inhibit or allow a deactivation of the switch output by way of the stop signal as a function of a stop control signal.

12. The control circuit according to claim 7, which comprises a comparator electrically coupled to the switch and configured to determine a switch status value of the switch by comparing a voltage drop across the switch with a predefined threshold voltage.

13. A combination, comprising:
a switching configuration having a switch and a relay, said switch selectively enabling said relay to be supplied with current or preventing said relay from being supplied with current depending on a switch setting thereof; and
a control circuit for said switching configuration, said control circuit having a hold signal input and a switch output connected to said switch, and said control circuit:
generating a hold signal for a predefined period of time upon receiving a start signal, wherein the start signal is formed by way of a reset signal or generated by way of a logic operation from the reset signal and a switching signal or generated by a deactivation of the switching signal;
generating the hold signal for the predefined period of time irrespective of a further characteristic of the start signal during the predefined period of time; and
activating said switch output as long as at least one of two conditions is satisfied and otherwise deactivating the switch output, wherein a first condition is satisfied when the control circuit is supplied with the switching signal and a second condition is satisfied when the switch output is activated at a commencement of a generation of the hold signal and the hold signal is generated; and
said switch output being electrically coupled to said switch such that said switch enables said relay to be supplied with current when said switch output is activated and otherwise said switch prevents said relay from being supplied with current.
